(19) United States
(12) Patent Application Publication
(10) Pub. No.: US 2016/0324188 A1
(43) Pub. Date: Nov. 10, 2016

(54) SYSTEMS AND METHODS FOR ESTIMATING FEED EFFICIENCY AND CARBON FOOTPRINT FOR MEAT PRODUCING ANIMAL

(71) Applicant: ALLTECH, INC., Nicholasville, KY (US)

(72) Inventors: James Dennison JOHNSTON, McNab/Braeside (CA); Robin Alexander JOHNSTON, Arnprior (CA); Tyler Cole BRAMBLE, Visalia, CA (US); Karl A. DAWSON, Lexington, KY (US)

(73) Assignee: Alltech, Inc., Nicholasville, KY (US)

(21) Appl. No.: 15/108,976

(22) PCT Filed: Dec. 31, 2014
(86) PCT No.: PCT/US2014/072935

§ 371 Date: Jun. 29, 2016

(30) Foreign Application Priority Data
Jan. 2, 2014 (CA) 2839029

(51) Int. Cl. A23K 20/10; A23K 50/10; G06Q 10/06

(52) U.S. Cl. CPC A23K 20/10; G06Q 10/063; A23K 50/10

(57) ABSTRACT

Systems and methods for estimating meat producing animal feed conversion efficiency and carbon footprint, such as to allow adjustments to be made in the animals feed to improve meat production, reduce waste, and/or reduce the carbon footprint. In embodiments of the present application, a system is provided that integrates a digestion model of an animal feed with weight gain efficiency and carbon footprint. Such systems and methods are useful to analyze and compare different animal feed compositions that differ from one another in one or more components and/or to analyze the effect of the addition of a feed supplement on weight gain efficiency and/or carbon footprint. In embodiments, the systems and methods described herein provide a feed parameter-carbon footprint compromise. A feed parameter-carbon footprint compromise is useful to adjust animal feed composition by balancing weight gain efficiency with effects on carbon footprint. Different feed supplements or amounts of feed supplements, and/or different feed compositions are selected based on the desired feed parameter-carbon footprint compromise.

### CROSS-REFERENCE TO RELATED APPLICATION(S)

This application is being filed on Dec. 31, 2014, as a PCT International Patent application and claims priority to Canadian Patent Application Serial No. 2839029 filed on Jan. 2, 2014, the disclosure of which is incorporated herein by reference in its entirety.

### TECHNICAL FIELD

This application relates to a systems and methods for estimating and optimizing feed efficiency and carbon footprint for meat producing animal(s).

### BACKGROUND

Certain types of animals, referred to herein as meat producing animals, are commonly raised for the primary purpose of producing meat that will ultimately be sold to businesses or consumers as a source of food.

Meat producing animals obtain the nutrients needed for meat production through the food that they eat. The composition of animal feed is often selected in an attempt to provide the animals with the proper nutrition needed to support meat production. Any portion of the animal feed that is indigestible by the animal passes through the animal without benefiting meat production. The cost attributable to such portions of the animal feed is, at least in theory, an unnecessary expense. Accordingly, it would be beneficial if the composition of the animal feed could be evaluated and adjusted to reduce the portion of the animal feed that is indigestible by the meat producing animal.

Another consideration in the selection of animal feed is the extent of greenhouse gases generated and/or emitted from meat producing animals after they consume the animal feed. Some compositions of animal feed will cause the meat producing animal to generate more greenhouse gases than others. The greater the greenhouse gas emission, the greater the carbon footprint of the meat producing animal or collection of meat producing animals. Accordingly, it would be beneficial if the composition of the feed could be evaluated and adjusted to reduce the resulting carbon footprint.

### SUMMARY

The present application relates to systems and methods for estimating meat producing animal feed conversion efficiency and carbon footprint, such as to allow adjustments to be made in the animals' feed to improve meat production, reduce waste, and/or reduce the carbon footprint. In embodiments of the present application, a system is provided that integrates a digestion model of an animal feed with weight gain efficiency and carbon footprint. Such systems and methods are useful to analyze and compare different animal feed compositions that differ from one another in one or more components and/or to analyze the effect of the addition of a feed supplement on weight gain efficiency and/or carbon footprint. In embodiments, the systems and methods described herein provide a feed parameter-carbon footprint compromise. A feed parameter-carbon footprint compromise is useful to adjust animal feed composition by balancing weight gain efficiency with effects on carbon footprint. Different feed supplements or amounts of feed supplements, and/or different feed compositions are selected based on the desired feed parameter-carbon footprint compromise. The systems and methods can be used for a single animal or a plurality of animals.

The present application includes a method for estimating impact of a meat producing animal on carbon footprint, comprising: providing one or more primary parameters associated with one or more of: a) a measure of energy content for a selected feed sample from a digestion model associated with the meat producing animal; b) a measure of dry matter digestibility for the selected feed sample from the digestion model associated with the meat producing animal; and c) an amount or a percent of components in the feed sample; producing with a computing device a baseline performance comprising one or more of weight gain and feed efficiency using at least one or more of the primary parameters and one or more secondary parameters for the meat producing animal, wherein the one or more secondary parameters are associated with one or more of: a measure of animal weight, a meat price, a measure of animal dry matter intake, a breed of the animal, a measure of animal activity, and a measure of one or more environmental conditions; and producing with the computing device a carbon footprint for the meat producing animal using the baseline performance.

In some embodiments, a method for adjusting a feed composition, comprises: a) digesting a feed sample in an in vitro fermentation system for a meat producing animal to generate a value for a primary parameter comprising a) a measure of energy content for a selected feed sample from a digestion model associated with the meat producing animal; b) a measure of dry matter digestibility for the selected feed sample from the digestion model associated with the meat producing animal; b) measuring one or more secondary parameters selected from the group consisting of animal weight, animal meat production, animal dry matter intake, animal meat price, animal activity, and an environmental condition to generate a value for the one or more secondary parameters; c) producing a baseline performance value comprising meat production efficiency using at least one or more of the values of the primary parameters and one or more of the values of the secondary parameters using a computing device; d) producing a carbon footprint for the meat producing animal using the baseline performance using a computing device; and e) adjusting a component of the feed sample to change the baseline performance, the carbon foot print or both.

In other embodiments, a method for adjusting a feed composition, comprises: a) determining a characteristic of a first feed sample to generate a value for a primary parameter; b) measuring one or more secondary parameters selected from the group consisting of animal weight, animal meat production, animal dry matter intake, animal meat price, animal activity, and an environmental condition to generate a value for the one or more secondary parameters; c) producing a baseline performance value comprising meat production efficiency using the value of the primary parameter and one or more of the values of the secondary parameters using a computing device; d) producing a carbon footprint for the meat producing animal using the baseline performance using a computing device; and e) adjusting a component of the first feed sample to change either the baseline performance, the carbon foot print or both.

In embodiments, the steps of methods described herein are repeated until a feed composition is identified that maintains or increases meat production efficiency and decreases carbon footprint as compared to the first feed sample.

In some embodiments the digestion model is a chemical or biological fermentation model. In some embodiments the biological fermentation model is an in vitro biological model. In some embodiments, the in vitro digestion system comprises digesting the feed sample with one or more digestive enzymes in the presence of a microbial population.

Some embodiments further include displaying the carbon footprint for the meat producing animal. In some embodiments the displaying comprises displaying the carbon footprint for the meat producing animal as a function of feed intake of the animal. In some embodiments the producing with the computing device comprises calculating with the computing device.

Examples of primary parameters include a measure of energy content or a measure of dry matter digestibility for a selected feed sample from a digestion model associated with the meat producing animal. In some embodiments the digestion model is a chemical or biological fermentation model. In some embodiments the biological fermentation model is an in vitro biological model.

Examples of an amount or percent of components in the feed sample include but are not limited to, an amount or percentage one or more of a measure of fat, a measure of carbohydrate, a measure of protein, a measure of calories, a measure of fiber, a measure of calcium, a measure of dry matter, a measure of gross energy, or a measure of phosphorous.

In embodiments, determining the characteristic of the feed sample comprises measuring a characteristic of the feed sample. In other embodiments, determining the characteristic of the feed sample comprises calculating a characteristic of the feed sample. In further embodiments, the characteristic of the feed sample is determined by a chemical method or by near infrared spectroscopy.

Secondary parameters include but are not limited to a measure of animal weight, a measure of animal dry matter intake, a meat price, a breed of the animal, a measure of animal activity, and a measure of one or more environmental conditions. In embodiments, a measure of animal weight comprises a birth weight, a goal weight, average daily weight gain, weight gain per unit of time (e.g. from time period A to time period B), and a carcass weight. Weight can be represented as kilograms or as a percentage of the total weight of the animal.

In embodiments, a secondary parameter includes yield. An example of a yield calculation is dressing percent times carcass cutting yield times live weight. Dressing percent is determined by dividing carcass weight by live weight. Carcass cutting yield is the pounds of meat that result after cutting the meat and is calculated by the pounds of cut meat divided by the live weight.

In embodiments, a meat price includes but is not limited to meat price per kg, carcass price per kg and weight price per kg.

In some embodiments the one or more environmental conditions include temperature, humidity, time of year, wind speed, area of enclosure, and animal density per area of enclosure.

Some embodiments further include producing with the computing device feed efficiency in unit of feed consumed per unit of meat production. Some embodiments include producing with the computing device net energy required to support meat output in unit weight/time based at least in part on one or more of the primary parameters. Other embodiments include producing with a computing device escape protein in units of weight. Further embodiments include producing with the computing device a change in weight gain or feed efficiency for feed augmented with one or more feed supplements as compared to a baseline performance without a feed supplement. In some embodiments, producing with the computing device a change in weight gain or feed efficiency comprises an amount of the one or more feed supplements needed to obtain increased weight gain or feed efficiency. In embodiments, a change in weight gain or efficiency can be determined by holding the values of one or more secondary parameters constant based on expected or desired outcomes, such as, desired weight gain per day.

In embodiments, adjusting a component of the feed sample comprises adding a feed supplement to the feed sample. In specific embodiments, adjusting a component of the feed sample comprises altering the form of protein or amount of protein in the sample. In other embodiments, adjusting a component of the feed sample comprises altering the digestibility of the feed sample.

The present application also includes a method for estimating impact of a plurality of meat producing animals on carbon footprint, comprising: providing one or more primary parameters associated with one or more of: a) a measure of energy content for a selected feed sample from a digestion model associated with the meat producing animal; b) a measure of dry matter digestibility for the selected feed sample from the digestion model associated with the meat producing animal; and c) an amount or a percent of components in the feed sample; producing with a computing device a performance for each animal comprising weight gain or feed efficiency using at least one or more of the primary parameters and one or more secondary parameters for each meat producing animal, wherein the one or more secondary parameters are associated with one or more of: a measure of animal weight, a meat price, a measure of animal dry matter intake, breed of animal, a measure of animal activity, and a measure of one or more environmental conditions; producing with the computing device a carbon footprint per animal using the baseline performance; and aggregating the carbon footprint per animal for each animal of the plurality of meat producing animals to provide an aggregate carbon footprint.

Some embodiments further include displaying the carbon footprint for each animal of the plurality of meat producing animals. Other embodiments further include displaying the aggregate carbon footprint for the meat producing animals as a function of weight gain or feed efficiency of the animals.

In some embodiments the plurality of meat producing animals includes animals of different species or from different phylogenetic families. In some embodiments the plurality of meat producing animals is animals of the same species or from same phylogenetic family. In other embodiments the producing with the computing device comprises calculating with a computing device.

In some embodiments the one or more primary parameters further include one or more of: a measure of fat, a measure of carbohydrate, a measure of protein, a measure of fiber, a measure of calcium, and a measure of phosphorous.

In some embodiments the digestion model is a chemical or biological fermentation model. In some embodiments the biological fermentation model is an in vitro biological model.

Some embodiments further include producing with a computing device feed efficiency in unit weight of feed consumed per unit weight gain. Some embodiments further include producing with a computing device NRC metabolizable protein required to support meat production in unit weight/time based on one or more of the primary parameters or based on one or more of the secondary parameters. Some embodiments further include producing with a computing device escape protein in units of weight. Additional embodiments include producing with a computing device a change in weight gain or feed efficiency for feed augmented with one or more feed supplements. In some embodiments producing with the computing device a change in weight gain or feed efficiency comprises calculating an amount of the one or more feed supplements needed to obtain an increase in weight gain or an increase in feed efficiency. In some embodiments the producing with a computing device a carbon footprint per animal includes producing a carbon footprint per animal using the increased weight gain or increased feed efficiency.

In some embodiments the aggregating the carbon footprint per animal for each animal of a plurality of animals includes aggregating a carbon footprint per animal for each animal of the plurality of animals with feed augmented with the one or more feed supplements, to provide an aggregate carbon footprint as a function of an amount of the one or more feed supplements, weight gain, or feed efficiency. Some embodiments further include displaying the aggregate carbon footprint as a function of the selected amount of the one or more feed supplements, weight gain or feed efficiency.

Some embodiments further include producing with a computing device a required protein level or protein savings.

The present application further includes a method for estimating an increase in one or more of weight gain and weight gain efficiency in a meat producing animal provided with animal feed containing one or more feed supplements, comprising: providing a baseline performance comprising one or more of weight gain and feed efficiency for the meat producing animal; providing a selected amount of one or more feed supplements; and producing with the computing device an increase in one or more of weight gain and feed efficiency in the meat producing animal fed using the selected amount of the one or more feed supplements relative to the baseline performance.

Some embodiments further include producing with a computing device a carbon footprint for the animal. Some embodiments also include displaying the carbon footprint as a function of the selected amount of the one or feed supplements, weight gain, or feed efficiency. Other embodiments include producing with a computing device a required dietary protein or protein savings.

The present application also includes a method for estimating an increase in one or more of weight gain and weight gain efficiency in a plurality of meat producing animals provided with animal feed containing one or more feed supplements, comprising: providing a baseline performance comprising one or more of weight gain and feed efficiency for the plurality of meat producing animals; providing a selected amount of one or more feed supplements; and producing with a computing device an increase in one or more of weight gain and feed efficiency per animal in the plurality of meat producing animals fed using the selected amounts of the one or more feed supplements relative to the baseline performance.

Some embodiments also include producing with the computing device a carbon footprint per animal for each animal of the plurality of animals. Some embodiments further include aggregating the carbon footprint per animal for each animal of the plurality of animals to provide an aggregate carbon footprint as a function of the selected amount of the one or more feed supplements, animal daily weight gain, or feed efficiency. Some embodiments further include displaying the carbon footprint as a function of the selected amount of the one or more feed supplements, animal daily weight gain, or feed efficiency.

The present application also includes a system for estimating the impact of a meat producing animal on carbon footprint, the system comprising: at least one processing device; and at least one computer readable storage device, the at least one computer readable storage device storing data instructions that, when executed by the at least one processing device cause the at least one processing device to generate: a baseline performance engine configured to receive one or more primary parameters associated with one or more of a measure of energy content and a measure of dry matter digestibility, and to produce a baseline performance comprising one or more of weight gain and feed efficiency using at least one of the primary parameters and one or more secondary parameters, wherein the one or more secondary parameters are associated with one or more of a measure of animal weight, a measure of animal dry matter intake, a breed of animal, a measure of animal activity, and a measure of one or more environmental conditions, and a carbon footprint engine configured to use the baseline performance to produce a carbon footprint for the animal.

Some embodiments further include a display device, wherein the carbon footprint for the animal is displayed on the display device as a function of feed intake, weight gain, or feed efficiency of the animal. Other embodiments include a plurality of computing devices, wherein a first processing device is part of a first computing device. In some embodiments one computing device produces the baseline performance and the carbon footprint. In some embodiments the baseline performance engine operates on a first computing device and wherein the carbon footprint engine operates on a second computing device. In some embodiments the first computing device is in data communication with the second computing device across one or more data communication networks. In other embodiments the baseline performance engine is configured to calculate the baseline performance and the carbon footprint engine is configured to calculate the carbon footprint.

The present application further includes a system for estimating the impact of a plurality of meat producing animals on carbon footprint, the system comprising: at least one processing device; and at least one computer readable storage device, the at least one computer readable storage device storing data instructions that, when executed by the at least one processing device cause the at least one processing device to generate: a baseline performance engine configured to receive one or more primary parameters associated with one or more of a measure of energy content and a measure of dry matter digestibility, the baseline performance engine further configured to produce a baseline performance comprising weight gain or feed efficiency using at least one of the primary parameters and one or more secondary parameters, wherein the one or more secondary parameters are associated with one or more of: a measure of animal weight, a measure of animal dry matter intake, a meat price, a breed of animal, a measure of animal activity, and a measure of one or more environmental conditions; and a carbon footprint engine configured to use the baseline performance to produce a carbon footprint for each animal in the plurality of animals and aggregate the carbon footprint produced for each animal in the plurality of animals to provide an aggregate carbon footprint.

Some embodiments further include a display device, wherein the display device displays the aggregated carbon footprint for the plurality of animals as a function of animal feed intake, weight gain, or feed efficiency of the plurality of animals.

In some embodiments the baseline performance engine is configured to calculate the baseline performance and the carbon footprint engine is configured to calculate the carbon footprint.

Some embodiments include a plurality of computing devices, wherein a first processing device is part of a first computing device and a second processing device is part of a second computing device. In some embodiments the first computing device is in data communication with the second computing device across one or more data communication networks.

In some embodiments the plurality of meat producing animals includes animals of different species or from different phylogenetic families. In other embodiments the plurality of meat producing animals is animals of the same species or from same phylogenetic family.

### BRIEF DESCRIPTION OF THE DRAWINGS

FIG. 1 is a schematic block diagram illustrating an example system for estimating the impact of a meat producing animal on carbon footprint.

FIG. 2 is a schematic block diagram illustrating an example system for estimating the impact of a feed supplement on weight gain and/or carbon footprint of a meat producing animal.

FIG. 3 is a screen shot of an example user interface display 300 according to some embodiments of the present application.

### DETAILED DESCRIPTION

### Definitions

The following detailed description refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this application are not necessarily to the same embodiment, and such references contemplate more than one embodiment.

As used in this application, the term “animal(s)” refers to non-human animals raised or used as a source of food. For example, animals include, but are not limited to, domesticated livestock such as cattle, goats, sheep, pigs, buffalo, camel, horse, water buffalo, and fish and other aquatic animals. A “meat producing animal(s)” is an animal raised or used for meat production.

As used in this application, the term “baseline performance” refers to various aspects of a meat producing animal when the meat producing animal is fed animal feed without one or more optional feed supplements. Examples of baseline performance include a meat producing animal's weight gain and/or weight gain efficiency. The term “baseline performance engine” refers to a machine or portion of a machine that produces and/or calculates a baseline performance associated with a meat producing animal. In some embodiments, the baseline performance engine includes data instructions, which when executed by a processing device cause the processing device to produce and/or calculate a baseline performance.

As used in this application, the term “carbon footprint” refers to the generation and/or emission of a set of greenhouse gases. As used herein, carbon footprint is primarily focused on the generation and/or emission of greenhouse gases by a meat producing animal. Typical greenhouse gases generated by an animal include carbon dioxide and methane. Carbon footprint can refer to the generation and/or emission of gases by an individual animal or a collection of animals. The term “aggregate carbon footprint” refers to the sum of the carbon footprints of a collection of animals. A collection of animals can be part of a single farm or distributed across a collection of one or more farms or other locations. A collection of one or more animal locations is referred to herein as an “enterprise.” The term “carbon footprint engine” refers to a machine or portion of a machine that produces and/or calculates a carbon footprint associated with a meat producing animal or collection of meat producing animals. In some embodiments the carbon footprint engine includes data instructions, which when executed by a processing device cause the processing device to produce and/or calculate a carbon footprint.

As used herein in this application, the term “dry matter intake” (DMI) refers to the amount of a feed an animal consumes per day on a moisture free basis.

As used in this application, the term “estimating” refers to producing, determining, and/or calculating one or more values that predict or approximate an actual value.

As used in this application, the term “fermentation model(s)” or “digestion model(s)” refers to an in vitro digestion model that mimics in vivo digestion of an animal. In embodiments of the present application the animal is a ruminant animal. The gastrointestinal tract of ruminant animals is characterized by multi-compartment stomachs and microbial fermentation of components of the feed. An example of a fermentation or digestion model is a batch-culture, rumen-fluid, gas-fermentation system combined with mathematical analysis to allow for the differentiation of rapid and slowly-fermenting carbohydrate pools in individual feedstuffs or TMR samples. The rate and extent of organic matter degradation, can be determined with such system by monitoring gaseous fermentation products (CO2, methane) of microbial metabolism in addition to CO2 produced by the buffering of microbial produced short-chained fatty acids (SCFA, primarily acetate and butyrate).

As used in this application, the term “feed(s)” or “animal feed(s)” refers to material(s) that are consumed by animals and contribute energy and/or nutrients to an animal's diet. Animal feeds typically include a number of different components that may be present in forms such as concentrate(s), premix(es) co-product(s), or pellets. Examples of feeds and feed components include, but are not limited to, Total Mixed Ration (TMR), corn, soybean, forage(s), grain(s), distiller grain(s), sprouted grains, legumes, vitamins, amino acids, minerals, molasses, fiber(s), fodder(s), grass(es), hay, straw, silage, kernel(s), leaves, meal, soluble(s), and supplement(s). As used herein the term “selected animal feed(s)” refers to an animal feed selected for analysis using the methods and systems described herein.

As used in this application, the term “sample(s) of animal feed” or “feed sample(s)” refers to a representative portion of an animal feed. In embodiments of the present application, a representative portion of an animal feed contains the same components in similar proportions to that of the animal feed. A representative sample is preferably homogenous or substantially homogenous.

As used in this application, the term “feed efficiency” refers to a ratio of an amount of animal feed or component of animal feed that needs to be consumed by an animal to obtain a unit of production, such as weight gain, meat production, or egg production. The term “weight gain efficiency” refers to a ratio of an amount of animal feed or component of animal feed that needs to be consumed by a meat producing animal to increase the animal's weight by one unit. The term “meat production efficiency” refers to a ratio of an amount of animal feed or component of animal feed that needs to be consumed by a meat producing animal to obtain a unit of meat production.

As used in this application, the term “feed parameter(s)” refers to one or more qualities or characteristics associated with an animal feed sample. One example of a feed parameter is a cost of the feed, such as per unit weight or per unit volume.

As used in this application, the term “feed parameter-carbon footprint compromise” refers to a solution determined by balancing one or more feed parameters against one or more carbon footprint parameters. The term “optimal feed parameter-carbon footprint compromise” refers to a most preferred solution determined by balancing one or more feed parameters against one or more carbon footprint parameters.

As used in this application, the term “feed supplement” refers to an animal feed additive that, when combined with an animal feed, causes an increased weight gain, weight gain efficiency, meat production, or meat production efficiency.

As used in this application, the term “heat production” refers to an estimate of the heat produced when feed is ingested and utilized. Heat production can be estimated by measuring oxygen consumed and carbon dioxide and methane produced. Heat increment is calculated as the difference between heat production in fed animals and the heat production in animals that were fasted.

As used in this application, the term “in vivo” refers to processes occurring within a living biological organism.

As used in this application, the term “in vitro” refers to processes occurring in an artificial environment outside the living organism and to biological processes or reactions that would normally occur within an organism but are made to occur in an artificial environment. In vitro environments can include, but are not limited to, test tubes and cell culture.

As used in this application, the term “measure” refers to a quantifiable unit.

As used in this application, “metabolizable energy” (ME) refers to the digestible energy (DE) minus the energy lost as waste products. “Digestible energy” gives an indication of the actual amount of energy the animal has for use. Digestible energy can be calculated by determining the total gross energy (GE) content in the feed and subtracting the fecal energy. Digestible energy can also be calculated by the product of the gross energy of a feed sample and the dry matter digestibility of the feed sample. The term “energy content” refers to the gross energy in the feed. Gross energy can be determined using analysis in a bomb calorimeter or by techniques such as NIR. Fecal energy can be determined by bomb calorimetry of fecal samples. Metabolizable energy can be calculated by multiplying the digestible energy by a conversion coefficient. For example, for beef cattle ME=0.82×DE. Such conversion coefficients and values for net energy of maintenance, metabolizable energy, net energy of gain for types of feed are available from United States Canadian Tables of Feed Composition (National Academies Press website).

As used in this application, the term “dry matter digestibility” refers to the amount or percent of the gross energy contained in a feed sample that is digestible by the animal to provide usable energy to the animal.

As used in this application, the term “nutrient(s)” refers to a substance that is needed for an organism to live and/or grow. Nutrients include, but are not limited to, compounds such as protein, fat, carbohydrates (e.g., sugars), fiber, vitamins, calcium, iron, niacin, nitrogen, oxygen, carbon, phosphorus, potassium, sodium chloride, and mixtures thereof. The term “total digestible nutrients” refers to a sum of the digestible nutrients in an animal feed, often determined from a digestion model as defined herein.

As used in this application, the term “net energy” refers to metabolizable energy minus the heat increment of feeding. Net energy includes “net energy for maintenance” and “net energy for growth”. As used in this application, the term “Net energy for growth” as used herein is an estimate of the energy value of a feed used for weight gain. As used in this application, the term “Net energy for maintenance” as used herein is an estimate of the energy value of a feed used to keep and animal in energy equilibrium, without gaining or losing weight. Value for net energy for different feeds are available from United States Canadian Tables of Feed Composition (National Academies Press website).

As used in this application, the term “primary parameter(s)” refers to data or information relating to energy content of a feed sample. Examples of primary parameters include a) a measure of energy content for a feed sample; b) a measure of dry matter digestibility for a feed sample; net energy of the feed sample; and c) an amount or a percent of components in the selected feed sample.

As used in this application, the term “secondary parameter(s)” refers to data or information relating to factors that may influence an animal's meat production or carbon footprint, or the value or cost of same. Examples of secondary parameters include a measure of animal weight, a measure of animal meat production, a birth weight, a goal weight, an average daily weight gain, a processing age for the animal, a carcass weight, a yield, a meat price, a measure of animal meat protein, a measure of animal dry matter intake, a measure of animal dietary protein, a measure of an activity level, and a measure of environmental conditions. The term “carcass weight” refers to a weight of an animal's carcass after being partially butchered, such as after removal of one or more of the head, skin, internal organs, legs, and tail. The carcass includes the muscle, bones, fat, and other body tissues that remain after the partial butchering. The term “yield” refers to a percent of the carcass weight that remains after the carcass has been butchered into specific cuts of meat.

As used in this application, the term “microbial protein” refers to the protein provided by rumen microbes in a ruminant, or generated through a digestion model of a ruminant. Microbial protein is one of the sources of protein for a meat producing animal.

As used in this application, the term “metabolizable protein” refers to a sum of protein and amino acids reaching the small intestine from ruminally undegraded protein (RUP) and microbial protein, in ruminants. Microbial protein is one source of metabolizable protein in a meat producing animal. The term “NRC metabolizable protein” refers to how much protein is required to support the desired meat production. The NRC metabolizable protein requirements in gms/day are provided by the National Research Council of the United States (such as available at the National Academies Press website) or Canada.

As used in this application, the term “escape protein” or “rumen-undegradable protein” (RUP) refers to a portion of protein in an animal feed that resists rumen degradation.

As used in this application, the term “rumen degradable protein” (RDP) refers to a portion of protein in an animal feed that degraded in the rumen and can be digested in the stomach of a meat producing animal.

As used in this application, the term “protein savings” refers to an amount or percent of protein in excess of a baseline performance. For example, the protein savings is an additional amount of protein digested by a meat producing animal when fed a feed supplement along with an animal feed.

### DETAILED DESCRIPTION

The present application relates to systems and methods for estimating and optimizing meat producing animal feed conversion and carbon footprint.

In embodiments of the present application, a system is provided that integrates a digestion model of an animal feed with meat production efficiency and carbon footprint. Such systems and methods are useful to analyze and compare different animal feed compositions that differ from one another in one or more components and/or to analyze the effect of the addition of a feed supplement on meat production efficiency and/or carbon footprint.

In some embodiments, an animal feed sample is tested to determine an energy content of the feed sample. For example, in some embodiments the feed sample is analyzed in a bomb calorimeter. In other embodiments, the feed sample is analyzed using NIR techniques.

In embodiments, an animal feed sample is digested using an in vitro fermentation model to generate a measure of dry matter digestibility, to determine an amount or percent of the energy in the feed sample that is available as energy to the animal. The primary parameters can be used along with one or more secondary parameters, such as animal weight (kg), animal meat production (kg), birth weight (kg), goal weight (kg), average daily weight gain (kg), processing age for the animal (days), carcass weight (kg), yield (%), meat price ($/kg), animal meat protein (%), animal dry matter intake (kg), animal dietary protein (%), activity level, and environmental conditions to produce a baseline performance of weight gain, weight gain efficiency, meat production, or meat production efficiency. The baseline performance and other parameters are entered into a carbon footprint engine. Such parameters comprise farm variables and/or meat production efficiency measure of the baseline performance. Farm variables include but are not limited to number of animals in herd, average live weight, average base meat price, farm size and combinations thereof. Other parameters include but are not limited to weight gain yield, herd culling rate, calving interval, first calving age, total feed use per kg weight gain, diet soya inclusion rate, nitrogen use per ha, diesel use per cow, electric use per kilogram weight gain and combinations thereof. The output of carbon footprint includes grams CO₂.

In embodiments, the systems and methods described herein provide feed parameter-carbon footprint compromise. A feed parameter-carbon footprint compromise is useful to adjust animal feed composition by balancing meat production efficiency with effects on carbon foot print. Different feed supplement or amounts of supplements, and/or different feed compositions are selected based on the desired feed parameter-carbon footprint compromise. The systems and methods can be used for a single animal or a plurality of animals.

Method for Estimating Impact of Meat Producing Animal(s) on Carbon Footprint

The present application includes a method for estimating impact of a meat producing animal on carbon footprint, comprising providing one or more primary parameters associated with one or more of: a) a measure of energy content for a selected feed sample from a digestion model associated with the meat producing animal; b) a measure of dry matter digestibility for the selected feed sample from the digestion model associated with the meat producing animal; and c) an amount or a percent of components in the feed sample; producing with a computing device a baseline performance comprising one or more of weight gain and feed efficiency using at least one or more of the primary parameters and one or more secondary parameters for the meat producing animal, wherein the one or more secondary parameters are associated with one or more of: a measure of animal weight, a measure of animal dry matter intake, a breed of the animal, a meat price, a measure of animal activity, and a measure of one or more environmental conditions; and producing with the computing device a carbon footprint for the meat producing animal using the baseline performance.

The present application further includes a method for estimating impact of a plurality of meat producing animals on carbon footprint, comprising providing one or more primary parameters associated with one or more of: providing one or more primary parameters associated with one or more of: a) a measure of energy content for a selected feed sample from a digestion model associated with the meat producing animal; b) a measure of dry matter digestibility for the selected feed sample from the digestion model associated with the meat producing animal; and c) an amount or a percent of components in the feed sample; producing with a computing device a performance for each animal comprising weight gain or feed efficiency using at least one or more of the primary parameters and one or more secondary parameters for each meat producing animal, wherein the one or more secondary parameters are associated with one or more of: a measure of animal weight, a measure of animal dry matter intake, a meat price, breed of animal, a measure of animal activity, and a measure of one or more environmental conditions; producing with the computing device a carbon footprint per animal using the baseline performance; and aggregating the carbon footprint per animal for each animal of the plurality of meat producing animals to provide an aggregate carbon footprint.

In embodiments, a method for adjusting a feed composition, comprises: a) digesting a feed sample in an in vitro fermentation system for a meat producing animal to generate a value for a primary parameter comprising a) a measure of energy content for a selected feed sample from a digestion model associated with the meat producing animal; b) a measure of dry matter digestibility for the selected feed sample from the digestion model associated with the meat producing animal; b) measuring one or more secondary parameters selected from the group consisting of animal weight, animal meat production, animal dry matter intake, animal meat price, animal activity, and an environmental condition to generate a value for the one or more secondary parameters; c) producing a baseline performance value comprising meat production efficiency using at least one or more of the values of the primary parameters and one or more of the values of the secondary parameters using a computing device; d) producing a carbon footprint for the meat producing animal using the baseline performance using a computing device; and e) adjusting a component of the feed sample to change the baseline performance, the carbon foot print or both.

In other embodiments, a method for adjusting a feed composition, comprises: a) determining a characteristic of a first feed sample to generate a value for a primary parameter; b) measuring one or more secondary parameters selected from the group consisting of animal weight, animal meat production, animal dry matter intake, animal meat price, animal activity, and an environmental condition to generate a value for the one or more secondary parameters; c) producing a baseline performance value comprising meat production efficiency using the value of the primary parameter and one or more of the values of the secondary parameters using a computing device; d) producing a carbon footprint for the meat producing animal using the baseline performance using a computing device; and e) adjusting a component of the first feed sample to change either the baseline performance, the carbon foot print or both.

Primary Parameters

Some embodiments include providing or calculating one or more primary parameters. In some embodiments, primary parameters are generated by digesting a feed sample with an in vitro fermentation system. In some embodiments, the primary parameters include, but are not limited to, data or information relating to the energy content of an animal feed sample. Once provided or calculated, the primary parameters can be used to produce or calculate a baseline performance associated with an animal feed, for example, as described herein.

One example of a primary parameter is a measure of energy content for a selected feed sample from a digestion model associated with the meat producing animal. Another example of a primary parameter is a measure of dry matter digestibility for the selected feed sample from the digestion model associated with the meat producing animal. A further example of a primary parameter is an amount or a percent of components in the selected feed sample. Each of these example primary parameters are described in further detail herein.

Feed Samples

One of the examples of a primary parameter, discussed above, is an amount or a percent of components in a selected feed sample. Once an animal feed of interest has been identified, an amount or a percent of one or more components in the selected animal feed can be identified. In some embodiments of the present application, the amount or percent of components can be determined analytically using wet chemistry or spectroscopic methods such as NIR. In some embodiments, the amount or the percent is obtained from, retrieved from, or looked up in a table providing the amount or a percent of components in the selected feed sample including but not limited to dry matter, crude protein, crude digestible fiber, acid digestible fiber, neutral digestible fiber, minerals, vitamins, digestible energy, net energy, fat, gross energy, carbohydrate, protein, and combinations thereof. Examples of such tables are available for example, at the website for National Research Council of the United States.

Digestion Models

A drawback with using data identifying the components in a selected feed sample, however, is that there are numerous variables that can impact the digestion of animal feed by a meat producing animal. As a result, some embodiments utilize one or more digestion models to obtain a more accurate understanding of how a feed sample will be digested by meat producing animals.

In embodiments, the digestion model is a chemical or biological fermentation model. In other embodiments the biological fermentation model is an in vitro biological model. In embodiments, a feed sample is digested with one or more digestive enzymes in the presence or absence of a microbial population.

Some embodiments involve providing or calculating a measure of energy content (mega joules/kilogram) for a selected feed sample from an in vitro digestion model associated with the meat producing animal. Example of a suitable digestion model is the In Vitro Fermentation Model (IFM) (Alltech of Nicholasville, Ky., US) or the Fermentrics Gas Fermentation System (the “Fermentrics System”), (as described on the Fermentrics website). An in vitro digestion model comprises contacting a feed sample with one or more digestive enzymes and/or microbial populations under conditions of pH, time and temperature that simulates the in vivo digestive process of the animal. Adjustments in the digestive process such as pH, time and temperature are adjusted depending on the species of the animal.

Specific examples of fermentation digestion models include IFM and Fermentrics. The IFM process involves the fermentation of a feed sample (typically a total mixed ration (TMR)) by incubating the feed sample in buffered rumen fluid for 48 hours, which simulates the in vivo digestive process of a meat producing animal. During the process, volatile fatty acids and microbial biomass are produced, along with greenhouse gases such as carbon dioxide and methane. The IFM determines, for example, how carbohydrates and protein are fermented and as a result the amount or percent of nutrients that are available for digestion by a meat producing animal. In particular, in some embodiments the IFM provides a measure of microbial protein for the selected feed sample. The Fermentrics System utilizes a rumen-fluid batch culture, gas fermentation system to evaluate a feed sample and generate gas fermentation data, including carbohydrate (B₁, B₂, B₃) digestion rates.

Other embodiments involve providing or calculating a measure of dry matter digestibility for the selected feed sample from the digestion model associated with the meat producing animal. The dry matter digestibility can be calculated based on feed analysis by measuring neutral digestible fiber before and after in vitro digestion model.

In some embodiments, total digestible nutrients are calculated by dividing digestible energy by 0.44. Such conversion coefficients and values for net energy of maintenance, metabolizable energy, net energy of gain for types of feed are available from United States Canadian Tables of Feed Composition (National Academies Press website).

Secondary Parameters

Some embodiments of the present application, involve one or more secondary parameters. In some embodiments the secondary parameters include, but are not limited to, data or information relating to factors that may influence an animal's meat production or carbon footprint, or the value or cost of same. In some embodiments, one or more of the secondary parameters are measured. In some embodiments the secondary parameters are provided or calculated, and can be used along with the primary parameters to produce or calculate a baseline performance associated with an animal feed. Secondary parameters can in some cases be calculated using coefficients as published in look up tables. In other cases, the secondary parameter is measured, e.g. average weight gain per day. In yet other embodiments, a secondary parameter is a desired or expected amount e.g. goal weight.

One example of a secondary parameter is a measure of animal weight, such as a weight of a meat producing animal (such as 600 Kg).

Another example of a secondary parameter is a measure of an animal's birth weight (such as 38.5 Kg). Another example of a secondary parameter is a measure of an animal's goal weight. The difference between the goal weight and the birth weight indicates the amount of weight gain that needs to occur over the life of the animal. Another secondary parameter is a processing age which identifies a target life span for the animal before processing (such as in days). In embodiments, animal weight is weight gain per unit of time (e.g. from time period A to time period B), and a carcass weight. The carcass weight indicates an amount or percent of an animal that remains after partial butchering. In some embodiments, for example, a beef carcass weight is in a range of 62% to 64% of the animal's overall weight. Weight can be represented as kilograms or as a percentage of the total weight of the animal.

In embodiments, a secondary parameter includes yield. The yield indicates an amount or percent of an animal that remains after butchering into cuts of meat. In some embodiments, for example, the yield of beef cattle is in a range from about 55% to about 75% of the carcass weight. An example of a yield calculation is dressing percent times carcass cutting yield times live weight. Dressing percent is determined by dividing carcass weight by live weight. Carcass cutting yield is the pounds of meat that result after cutting the meat and is calculated by the pounds of cut meat divided by the live weight.

Another example of a secondary parameter is a measure of animal meat production. In some embodiments the measure of animal weight gain is expressed as a function of weight over a period of time (such as kilograms per day).

Another example of a secondary parameter is a measure of animal meat protein. In some embodiments the measure of animal meat protein is expressed an amount of protein per unit weight. In another embodiment, the measure of animal meat protein is expressed as a percent (such as 3.2%).

Another example of a secondary parameter is a measure of animal dry matter intake (DMI). In some embodiments the measure of animal dry matter intake is the weight of animal feed excluding water content. In some embodiments the measure of animal dry matter intake is expressed as a weight over a period of time (such as 22 Kg per day).

A further example of a secondary parameter is a measure of animal meat price. In some embodiments the measure of animal meat price is the value at which the meat can be sold per unit volume (such as dollars per kg). In some embodiments the meat price is an average price of an animal's meat, based on known averages of meat production in a meat producing animal.

Another example of a secondary parameter is a measure of animal dietary protein. In some embodiments the measure of dietary protein is expressed as an amount, while in other embodiments it is expressed as a percent (such as 16%).

Another example of a secondary parameter is animal activity. When an animal moves it consumes additional energy, which increases the required net energy for maintenance. In some embodiments animal activity includes whether or not an animal is permitted to graze. In other embodiments, animal activity includes a measure of the amount of animal activity, such as in terms of an amount of energy consumed by activity over a period of time, or in terms of other values that can be used to compute the animal's energy consumption due to activity.

Another secondary parameter includes one or more environmental conditions. Examples of environmental conditions include temperature, humidity, time of year, wind speed, area of enclosure, and animal density per area of enclosure. Environmental conditions can also cause the animal to consume additional energy, thereby increasing the required net energy for maintenance. For example, if the animal is in a cold environment, the animal's body will consume additional energy to generate heat.

Other secondary parameters include but are not limited to measure of fat, a measure of carbohydrates, a measure of fiber, a measure of calcium, a measure of phosphorous, or a measure of energy.

Any one or more of the secondary parameters, or other secondary parameters, can be used in various embodiments.

Producing a Baseline Performance

Some embodiments include producing a baseline performance comprising one or more of weight gain, feed efficiency, weight gain efficiency, meat production, and meat production efficiency, using at least one or more of the primary parameters and one or more secondary parameters for the meat producing animal. The baseline performance indicates one or more aspects of a performance of an animal feed absent the presence of optional feed supplements, for example.

In some embodiments of the present application, producing a baseline performance involves producing or calculating an estimate of a meat producing animal's weight gain when fed the animal feed sample, based upon one or more of the primary and secondary parameters. In some embodiments, producing a baseline performance involves producing or calculating an estimate of the meat producing animal's meat production efficiency when fed the animal feed sample, such as a measure of a volume of weight gain per unit weight of feed consumed. Some embodiments produce or calculate a measure of net energy required to support weight gain for the meat producing animal given the one or more secondary parameters.

A selected feed has a total (gross) energy content that can be determined as discussed herein. Once consumed by an animal, only a portion of the total energy content will be available to the animal as energy. This portion is quantified by the dry matter digestibility. Dry matter digestibility for a selected feed sample can be determined using an in vitro fermentation model as described herein. The portion available to the animal can be computed as the product of the total energy content and the dry matter digestibility (%), also referred to as metabolizable energy. Some of the metabolizable energy is lost to the heat increment of feeding. The remainder is the net energy, which includes both net energy for maintenance and net energy for growth. The net energy for maintenance can be calculated or estimated based on one or more of the secondary parameters, discussed herein. The difference between the net energy and the net energy for maintenance is the net energy for production. The net energy for production is the amount of energy that is available for weight gain and meat production. In some embodiments, the net energy for production can be used to calculate or estimate an amount of weight gain, such as in Kg/day. In embodiments, calculations can be determined based on a plurality measurements of weight gain per unit time and one or more of the measured primary parameters of the same feed sample from the in vitro digestion model to establish a predictive relationship between feed efficiency and one or more of the primary parameters. A variety of predictive relationships can be identified using statistical methods.

Weight gain can be converted into carcass weight gain (such as Kg/day) by multiplying by the carcass weight (%). The carcass weight gain can be converted into meat production (such as in Kg/day) by multiplying by the yield. The value of the meat production can be obtained by multiplying the meat production by the meat price.

In some embodiments the baseline performance includes an estimate of feed efficiency. Feed efficiency (kg per kg, or g per kg) can be computed by dividing the meat production (kg or g) by the dry matter intake (kg). Weight gain efficiency and meat production efficiency can be similarly computed for the respective weight gain or meat production of the animal. The carcass weight and yield values can be used to convert between weight gain and meat production, for example.

Other values are included in the baseline performance in some embodiments.

Producing a Carbon Footprint

Some embodiments include producing a carbon footprint for the meat producing animal using the baseline performance. In some embodiments, the carbon footprint is produced or calculated using a carbon footprint engine. One suitable example of a carbon footprint engine is the E-CO₂ carbon footprint software discussed herein. In some embodiments, the carbon footprint is produced or calculated using the baseline performance. In some embodiments the carbon footprint includes an estimated amount of greenhouse gas emissions that would be generated by one or more meat producing animals over a period of time. In some embodiments the estimate is a weight of the emissions over a period of time, and in other embodiments the estimate is a weight of the emissions per unit weight of meat producing animal over a period of time (such as kg CO₂/kg weight). In some embodiments the carbon footprint includes other aspects in addition to greenhouse gas emissions.

In some embodiments of the present application, the carbon footprint is displayed as a function of feed parameters to provide a feed parameter-carbon footprint compromise. A feed parameter-carbon footprint compromise is useful for selecting a feed composition or adjusting a feed composition in order to balance feed parameters with a desired carbon footprint. Feed parameters include one or more qualities or characteristics associated with an animal feed sample. One example of a feed parameter is a cost of the feed or feed component, such as a cost of the feed per unit weight or per unit volume. Another example of a feed parameter is the feed efficiency or meat production efficiency. Similarly, some embodiments include carbon footprint parameters. Carbon footprint parameters include one or more characteristics of a carbon footprint. One example of a carbon footprint parameter is a cost associated with the carbon footprint, such as a cost per unit weight.

In some cases, a more expensive animal feed may provide a reduced carbon footprint than a less expensive feed. As a result, the feed parameters and the carbon footprint parameters can be used to provide or calculate an optimal feed parameter-carbon footprint comprise. In some embodiments the optimal value is the value that has the lowest cost feed to achieve a carbon footprint having reduced carbon footprint as compared to a reference feed sample or other feed sample under consideration, for example.

Another example feed parameter-carbon footprint compromise includes determining a baseline carbon footprint for a feed using the methods and systems as described herein and then determining the effect of altering the feed composition on carbon foot print and selecting the feed composition that provides a decrease in carbon footprint form the baseline carbon foot print. For example, if it is desired to obtain a certain revenue per cow based on price of meat per unit weight, an initial feed composition is selected that has a level of net energy that provides for weight gain in kilograms sufficient to attain the desired revenue per cow. In embodiments, the meat production can be input into a carbon footprint engine to produce a baseline carbon foot print for that level of microbial protein. The effect of changes to the animal feed composition, such as adding at least one feed supplement, is assessed on meat production and carbon footprint. The process of changing the animal feed composition can be repeated until the feed supplement or combination of animal feed changes achieve the optimal feed parameter-carbon footprint compromise. In embodiments, the animal feed composition is adjusted to maintain meat production at a desired level while decreasing the carbon footprint from the baseline carbon footprint. Such analysis can be conducted in a single cow or plurality of cows. Such analysis can be conducted on an annual basis, and feed composition adjusted to decrease carbon footprint on an annual basis.

In embodiments, adjusting a component of the feed sample comprises adding a feed supplement to the feed sample. In further embodiments, adjusting a component of the feed sample comprises altering the form of protein or amount of protein in the sample. In yet other embodiments, adjusting a component of the feed sample comprises altering the digestibility of the feed sample.

Some embodiments include aggregating the carbon footprint per animal for each animal of the plurality of meat producing animals to provide an aggregate carbon footprint. As one example, the aggregate of the carbon footprint per animal is the sum of the individual meat producing animal carbon footprints among a collection of meat producing animals in an enterprise, for the selected feed sample.

In embodiment of the present application, the plurality of meat producing animals includes animals of different species or from different phylogenetic families. In other embodiments, the plurality of meat producing animals is animals of the same species or from same phylogenetic family. Typically the plurality of animals are of the same species and from the same herd. Herds range in size from about 5 to 500 animals or more.

Producing Feed Efficiency

Some embodiments include producing or calculating feed efficiency. In some embodiments the feed efficiency is produced or calculated in unit volume of weight gain per unit weight of feed consumed. In some embodiments the feed efficiency is computed by dividing the estimated meat production (with or without feed supplements) by the animal dry matter intake.

Additional embodiments include producing a change in meat production or feed efficiency for feed augmented with one or more feed supplements, as discussed in further detail herein. In some embodiments, producing the change in meat production or feed efficiency comprises calculating an amount of the one or more feed supplements needed to obtain increased meat production or increased meat production efficiency.

Producing NRC Metabolizable Protein

Some embodiments include producing NRC metabolizable protein required to support weight gain in unit weight/time based on one or more of the secondary parameters. In some embodiments the NRC metabolizable protein requirement is obtained from a lookup table or chart, such as available from the National Research Council, as discussed herein, such as based at least in part on the weight of the animal, and possibly additional of the secondary parameters, or other parameters.

Producing Escape Protein

Further embodiments include producing escape protein in units of weight. In embodiments, it is desirable to increase escape protein so that more protein can be absorbed in the small intestine

Routing

Some embodiments include or involve a routing mode of operation. The routing mode of operation involves fixing the animal's meat production or weight gain at a constant rate, and determining a reduction in the required dry matter intake or required energy content that can be accomplished by including one or more feed supplements as part of the animal's feed. The feed supplements can be used to increase the animal's digestion of the feed, so that the required dry matter intake and/or required energy content of the feed can be reduced without reducing the total amount of energy that the animal receives. In some embodiments of the present application an appropriate decrease in dry matter intake or in required energy content is produced or computed. In some embodiments a cost savings is determined based on the use of one or more feed supplements, as a result of the reduction in required dry matter intake or required energy content.

Increased Meat Production

In some embodiments feed supplements are used to increase meat production. The feed supplements can provide additional energy, or can include components that enhance the digestion of the feed or absorption of the energy into the animal's body, thereby in either case (or both) increasing the animal's energy intake. The increase in meat production can be estimated based on the amount or percent of energy consumed in excess of the energy required for maintenance (net energy of growth).

Increased Meat Production Efficiency

Some embodiments produce an estimate of an increase in meat production efficiency that can be obtained by the use of one or more feed supplements. The increase in meat production efficiency can be computed, for example, by computing the total increased meat production (the sum of the baseline meat production and the increased meat production, and dividing the total increased meat production by the dry matter intake).

Increased Revenue

Some embodiments produce an estimate of an amount of increased revenue that can be obtained by the use of one or more feed supplements. In some embodiments an estimate of the increased revenue is computed as the product of the increased meat production and the meat price.

Method for Estimating Impact of Feed Supplement on Production of Meat Producing Animal(s)

The present application also includes a method for estimating an increase in one or more of meat production, meat production efficiency, weight gain, and weight gain efficiency of a meat producing animal provided with animal feed containing one or more feed supplements, comprising providing a baseline performance comprising one or more of weight gain, meat production, and feed efficiency for the meat producing animal; providing a selected amount of one or more feed supplements; and calculating with the computing device an increase in one or more of weight gain, meat production, and meat production efficiency in the meat producing animal fed using the selected amount of the one or more feed supplements relative to the baseline performance.

In embodiments of the present application, a method comprises producing with the computing device a change in weight gain, meat production, or feed efficiency for feed augmented with one or more feed supplements. In embodiments, the change in weight gain, meat production, or feed efficiency comprises calculating an amount of the one or more feed supplements needed to obtain increased weight gain, meat production, or feed efficiency.

In some embodiments, a method for adjusting a feed composition, comprises a) digesting a feed sample in an in vitro fermentation system for a meat producing animal to generate a value for a primary parameter comprising a) a measure of energy content for a selected feed sample from a digestion model associated with the meat producing animal; b) a measure of dry matter digestibility for the selected feed sample from the digestion model associated with the meat producing animal; b) measuring one or more secondary parameters selected from the group consisting of animal weight, animal meat production, animal dry matter intake, animal meat price, animal activity, and an environmental condition to generate a value for the one or more secondary parameters; c) producing a baseline performance value comprising meat production efficiency using at least one or more of the values of the primary parameters and one or more of the values of the secondary parameters using a computing device; d) producing a carbon footprint for the meat producing animal using the baseline performance using a computing device; and e) adjusting a component of the feed sample to change the baseline performance, the carbon foot print or both.

In other embodiments, a method for adjusting a feed composition further comprises: Digesting a feed sample comprising a feed supplement in an in vitro fermentation system for a meat producing animal to generate a value for a primary parameter comprising a) a measure of microbial protein for the feed sample; or b) a measure of total digestible nutrients for the feed sample; Holding a value for one or more of the secondary parameters constant, wherein the secondary parameters selected from the group consisting of animal weight, animal meat production, animal meat protein, measuring animal dry matter intake, animal meat price, animal dietary protein and combinations thereof; producing a supplement performance value comprising meat production efficiency using at least one or more of the values of the primary parameters and one or more of the values of the secondary parameters using a computing device; producing a supplement carbon footprint for the meat producing animal using the supplement performance using a computing device; and comparing the supplement performance to the baseline performance and/or comparing the supplement carbon footprint to the carbon footprint and selecting the feed supplement that changes meat production efficiency, carbon foot print or both.

Such methods are useful to select a feed composition and/or a feed supplement in order to increase feed efficiency, and/or to balance any increase in feed efficiency with effects on carbon footprint. The methods may be repeated any number of times using different feed compositions and/or different feed supplements or amounts, and the results compared to one another to allow a selection of a feed composition and/or supplement that achieves the desired feed parameter-carbon footprint compromise.

Feed Efficiency/Meat Production Efficiency

In some embodiments the feed or meat production efficiency can be improved by feeding a meat producing animal one or more feed supplements along with an animal feed. Some embodiments involve estimating an increase in, or calculating an improvement in, feed efficiency, weight gain efficiency, meat production efficiency between the baseline performance and the supplement performance. The supplement performance refers to the an estimate of a performance associated with the meat producing animal when the meat producing animal is fed one or more feed supplements along with a selected animal feed. In embodiments, one or more of the secondary parameters can be held constant from the baseline performance. In other embodiments, one or more secondary parameters can be measured in an animal(s) fed with a supplement. In embodiments, one or more secondary parameters is set at a desired or expected value by a farmer or nutritionist.

Feed Supplements

Feed supplements as used herein refer to components that are added to a feed composition in order to change the characteristics of the feed composition. Feed characteristics include but are not limited to, a residual component after digestion, microbial protein, total digestible nutrients, nitrogen source, protein source, and neutral detergent fiber. Feed supplements are components that adjust digestibility of feed components such as protein, neutral detergent fiber, and non protein nitrogen. Feed supplements include but are not limited to, protein, amino acids, non protein nitrogen sources, enzymes, microbial protein, and microbial derived components. Specific examples of supplements include Amaize, Yea-Sacc, Fibrozyme, DEMP, Optigen, Bio-Mos/Actigen, monensin, tylosin, chlorotetracycline, zilpaterol, ractopamine, and natural or synthetic hormones.

Baseline Performance

In embodiments, of the present application a method provides a baseline performance comprising one or more of weight gain, meat production, or feed efficiency as described herein. A baseline performance of weight gain for a particular feed sample can be determined by calculating the amount of weight gain per unit of feed fed to the animal. In embodiments, a baseline performance comprising feed efficiency is produced using at least one of the primary parameters and one or more secondary parameters, wherein the one or more secondary parameters are associated with one or more of a measure of animal weight, a measure of animal weight gain, a measure of animal meat production, a measure of animal meat protein, a measure of animal dry matter intake, a breed of animal, a measure of animal activity, animal meat price, animal dietary protein, and one or more environmental conditions as described above. In embodiments, baseline performance is calculated based on a predictive relationship determined by one or more of the primary parameters measured for a particular feed sample and one or more secondary parameters that are constant or measured. Baseline performance results can be displayed and/or stored as described herein.

Supplement Performance

In embodiments, of the present application a method provides a supplement performance comprising one or more of meat production or meat production efficiency for a feed composition with at least one added feed supplement as described herein. A baseline of meat production for a particular feed sample with a supplement can be determined by calculating the amount of weight gain per unit of feed fed to the animal.

Once a supplement performance is generated, it is compared to a baseline performance for the feed composition without any added feed supplement. The effect of the supplement on performance is determined by identifying whether the presence or amount of the supplement results in a change in baseline performance. In embodiments, a feed supplement is selected that increases the meat production or meat production efficiency. In embodiments, the feed supplement is selected that that increases meat production or meat production efficiency while maintaining or decreasing a carbon foot print.

Carbon Footprint

As described above, the systems and methods of the present application comprise producing with the computing device a carbon footprint for the meat producing animal using the baseline performance or the supplement performance. In some embodiments the carbon footprint is produced or calculated using a carbon footprint engine. One suitable example of a carbon footprint engine is the E-CO₂ carbon footprint software, also known as the Alltech® “What-If” Tool available at “alltech.eco2project.com” through a cooperative effort of E-CO₂ of Crewe, Cheshire East, UK, and Alltech of Nicholasville, Ky., US. In some embodiments, the carbon footprint includes an estimated amount of greenhouse gas emissions that would be generated by one or more meat producing animals over a period of time. In some embodiments, the estimate is a weight of the emissions over a period of time, and in other embodiments the estimate is a weight of the emissions per unit weight of meat producing animal over a period of time (such as kg CO₂/kg weight). In some embodiments, the carbon footprint includes other aspects in addition to greenhouse gas emissions.

In embodiments, as described above, meat production or meat production efficiency can be determined for a plurality of animals and a carbon foot print for the plurality of animals can be aggregated to provide an aggregated carbon footprint for feed samples with or without a supplement.

In some embodiments of the present application, the carbon footprint is displayed as a function of feed parameters to provide a feed parameter-carbon footprint compromise in the presence or absence of a feed supplement. A feed parameter-carbon footprint compromise is useful for selecting a feed composition or adjusting a feed composition in order to balance feed parameters with a desired carbon footprint. Feed parameters include one or more qualities or characteristics associated with an animal feed sample. One example of a feed parameter is a cost of the feed or feed component, such as a cost of the feed per unit weight or per unit volume. Another example of a feed parameter is the feed efficiency or meat production efficiency. Similarly, some embodiments include carbon footprint parameters. Carbon footprint parameters include one or more characteristics of a carbon footprint. One example of a carbon footprint parameter is a cost associated with the carbon footprint, such as a cost per unit weight. In embodiments, the carbon footprint associated with the supplement performance is compared to that of the baseline performance and the feed supplement is selected that adjusts the characteristic of a carbon footprint parameter.

In some cases, a more expensive animal feed may provide a reduced carbon footprint than a less expensive feed. As a result, the feed parameters and the carbon footprint parameters can be used to provide or calculate an optimal feed parameter-carbon footprint comprise. In some embodiments, the optimal value is the value that has the lowest cost feed to achieve a reduced carbon footprint as compared to a reference feed sample or other feed composition under consideration, for example, a feed composition having a feed supplement.

Implementation and Display Using One or More Computing Devices

Some embodiments are implemented or include at least one processing device and at least one computer readable storage device. Computer readable storage devices store data instructions that, when executed by the at least one processing device cause the at least one processing device to implement the methods as described herein. In embodiments a computer readable storage device contains data instructions that, when executed by the at least one processing device cause the at least one processing device to generate: a baseline performance engine configured to receive one or more primary parameters associated with one or more of a measure of microbial protein and a measure of total digestible nutrients, and to produce a baseline performance comprising one or more of meat production and meat production efficiency using at least one of the primary parameters and one or more secondary parameters, wherein the one or more secondary parameters are associated with a measure of one or more of animal weight, animal meat production, animal meat protein, animal dry matter intake, animal meat price, and animal dietary protein; and a carbon footprint engine configured to use the baseline performance to produce a carbon footprint for the animal. In other embodiments, a carbon foot print is generated for a plurality of animals and aggregated as described herein.

An example of a processing device is a central processing unit. A wide variety of other processing devices can also be used in other embodiments, such as a microprocessor, or other device capable of processing data instructions. Some embodiments include multiple processing devices. The multiple processing devices can be part of a common device, or parts of separate devices. In some embodiments the processing devices include or are in data communication with a data communication device, which permit data communication between the processing devices. In some embodiments the processing devices can communicate with each other across one or more networks, such as the Internet, a cellular communication network, a local area network, or other communication network that supports data communication.

Some embodiments include one or more computer readable storage devices storing data instructions that, when executed by the at least one processing device cause the at least one processing device to perform one or more of the methods, operations, or functions disclosed herein. The computer readable storage device is a physical, tangible device. A computer readable storage device is or includes a non-transitory computer readable medium.

In some embodiments a processing device is, or is a part of, a computing device. An example of a computing device is a computer, such as a server, a desktop computer, a laptop computer, a tablet computer, a smartphone, and a wearable computing device. In some embodiments a computer readable storage device is part of the computing device, while in other embodiments it is separate from the computing device.

Some embodiments include a first processing device and a second processing device, wherein the first processing device is part of a first computing device and the second processing device is part of a second computing device. In some embodiments the first and second computing devices are local and in other embodiments the first and second computing devices are remote. Some embodiments include three or more computing devices. In some embodiments the first processing device operates to produce the baseline performance and the second processing device operates to produce the carbon footprint, as described herein.

Some embodiments further include a display device. In some embodiments the display device is part of or in data communication with a processing device. The display device can be a display device connected with a computing device, or may be a remote display device connected to another computing device.

The Drawings

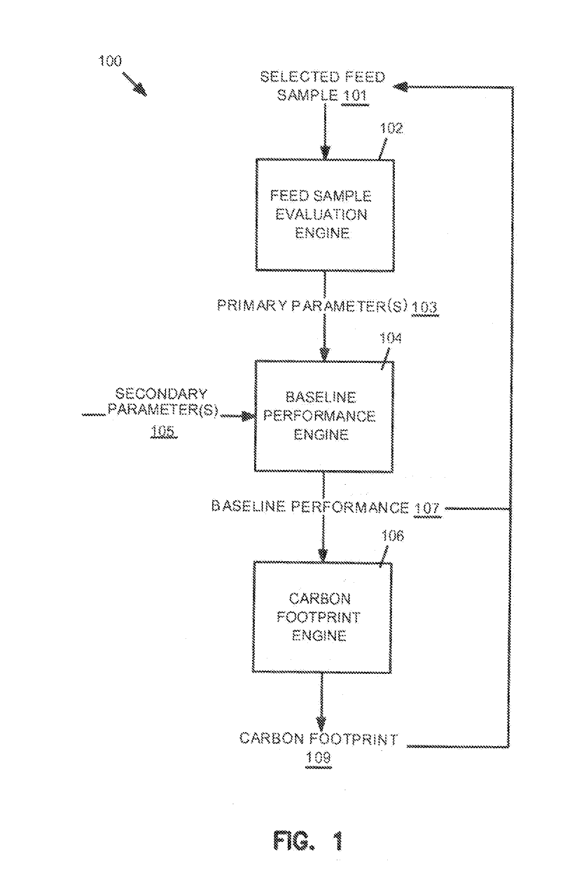

FIG. 1 is a schematic block diagram illustrating an example system 100 for estimating the impact of a meat producing animal on carbon footprint. In this example the system includes a feed sample evaluation engine 102, a baseline performance engine 104, and a carbon footprint engine 106. In some embodiments the system also involves a feed sample 101, primary parameters 103, secondary parameters 105, a baseline performance 107, and a carbon footprint 109.

In some embodiments the feed sample evaluation engine 102 receives a feed sample 101 or data or information related to a feed sample. Examples of the feed sample evaluation engine 102 include a digestion model. In another example, the feed sample evaluation engine 102 operates to evaluate an amount or a percent of one or more components in the selected feed sample 201, such as based on the information related to the feed sample.

The feed sample evaluation engine 102 generates one or more primary parameters 103 for the selected feed sample 101.

The baseline performance engine 104 utilizes the one or more primary and secondary parameters 103 and 105 to produce the baseline performance 107. In some embodiments the baseline performance engine 104 executes a set of data instructions to perform one or more computations of the primary and secondary parameters 103 and 105 to compute one or more baseline performance 107 values based on a predictive relationship.

The baseline performance 107 is provided to the carbon footprint engine 106, which operates to produce a carbon footprint 209 for one or more meat producing animals.

In some embodiments the baseline performance 107 and/or the carbon footprint 109 are used to adjust the selected feed sample 101, and the process is repeated to determine a baseline performance 107 and a carbon footprint for the adjusted selected feed sample 101.

In some embodiments the selection of the feed sample is automated by a computing device to determine an optimal feed parameter-carbon footprint compromise based on the baseline performance 107 and/or the carbon footprint 109.

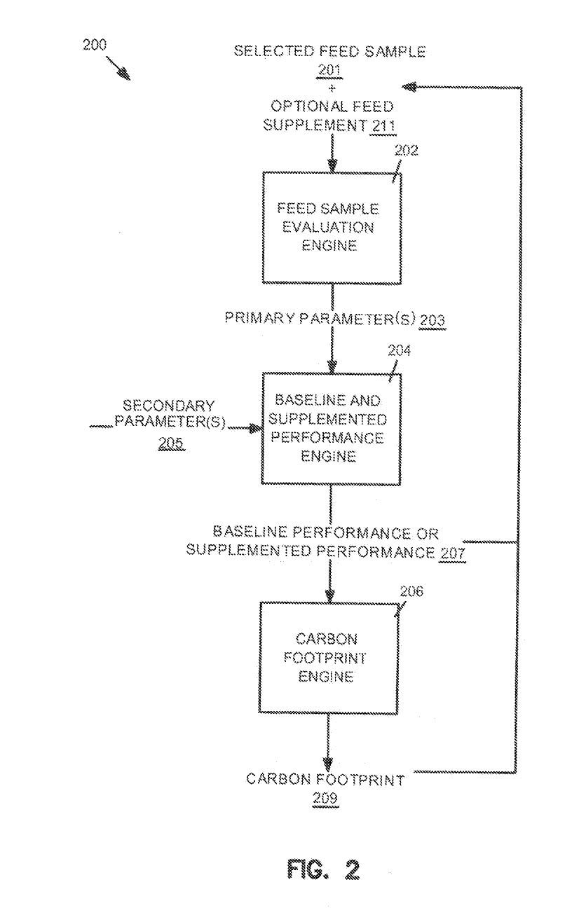

FIG. 2 is a schematic block diagram illustrating an example system 200 for estimating the impact of a feed supplement on production and/or carbon footprint of a meat producing animal. In this example the system includes a feed sample evaluation engine 202, a baseline performance and supplemented performance engine 204, and a carbon footprint engine 206. In some embodiments the system also involves a feed sample 201, primary parameters 203, secondary parameters 205, a baseline performance 207, a carbon footprint 209, and an optional feed supplement 211.

In some embodiments the feed sample evaluation engine 202 receives a feed sample 201 or data or information related to a feed sample. In some embodiments the selected feed sample 201 also includes an optional feed supplement 211. Examples of the feed sample evaluation engine 202 include a digestion model. In another example, the feed sample evaluation engine 202 operates to evaluate an amount or a percent of one or more components in the selected feed sample 201 and the feed supplement 211, such as based on the information related to the feed sample.

The feed sample evaluation engine 202 generates one or more primary parameters 203 for the selected feed sample 201 and the feed supplement 211.

The baseline performance and supplement performance engine 204 utilizes the one or more primary and secondary parameters 203 and 205 to produce the baseline performance or supplement performance 207. The baseline performance involves the performance without the optional feed supplement 211, while the supplement performance involves the performance with the optional feed supplement 211. In some embodiments, the baseline performance engine 204 executes data instructions, such as with one or more processing devices, to perform one or more computations of the primary and secondary parameters 203 and 205 to compute one or more baseline performance and supplement performance 207 values.

The impact of a feed supplement on production can be determined by comparing the baseline performance with the supplement performance.

The baseline and supplement performance 207 is provided to the carbon footprint engine 206, which operates to produce a carbon footprint 209 for one or more meat producing animals based on either or both of the baseline performance or the supplement performance 207.

In some embodiments the baseline performance 207 and/or the carbon footprint 209 are used to adjust the selected feed sample 201 and/or the optional feed supplement 211, and the process is repeated to determine a baseline performance 207 and a carbon footprint for the adjusted selected feed sample 201 and optional feed supplement 211.

In some embodiments the selection of the feed sample is automated by a computing device to determine an optimal feed parameter-carbon footprint compromise based on the baseline performance 207 and/or the carbon footprint 209.

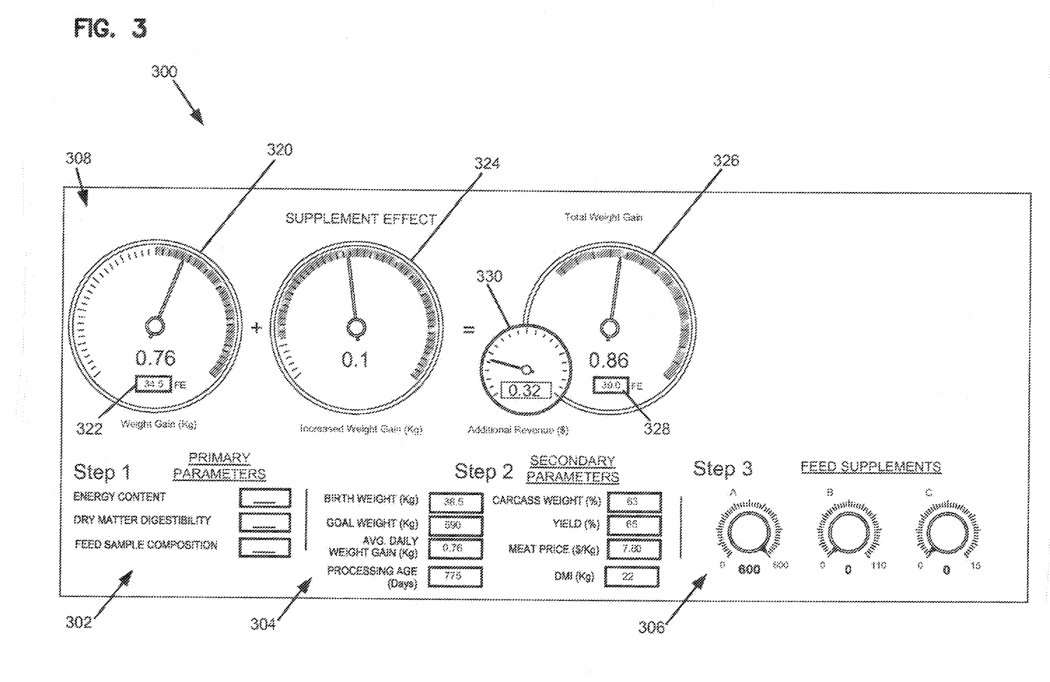

FIG. 3 is a screen shot illustrating an example user interface display 300 according to the present disclosure. In some embodiments the user interface display 300 is generated by the baseline performance engine 104, shown in FIG. 1. In other embodiments the user interface display 300 is a display generated by the baseline and supplemented performance engine 204, shown in FIG. 2.

In the illustrated example, the display 300 includes a primary parameters section 302, a secondary parameters section 304, a feed supplements section 306, and a supplement effect section 308.

In some embodiments, the primary parameters section 302 displays one or more primary parameters received from another source. In some embodiments, at least one of the primary parameters is received from a digestion model. In another possible embodiment, the primary parameters section 302 is an input section into which a user can enter one or more primary parameters. In this example, the primary parameters include energy content, dry matter digestibility, and feed sample composition.

The secondary parameters section 304 is provided in some embodiments to display one or more secondary parameters. In this example, the secondary parameters include birth weight, goal weight, average daily weight gain, processing age, carcass weight, yield, meat price, and dry matter intake. Other embodiments include other or different secondary parameters, such as those discussed herein.

The feed supplements section 306 is provided in some embodiments to permit the selection of one or more feed supplements. In this example the user interface display 300 includes three selectable and/or adjustable controls that the user can manipulate to adjust the amounts of one or more feed supplements to be included in the animal feed. In this example the feed supplements are Amaize, Yea-Sacc, Fibrozyme, DEMP, Optigen, Bio-Mos/Actigen, monensin, tylosin, chlorotetracycline, zilpaterol, ractopamine, and natural or synthetic hormones. Other embodiments include other feed supplements. In this example the DEMP feed supplement is selected for inclusion in the feed.

Some embodiments include a supplement effect section 308. In some embodiments the supplement effect section graphically displays an effect that the supplement has on the meat production and/or feed efficiency.

In the illustrated example, the supplement effect section 308 includes a weight gain display 320, a feed efficiency display 322, an increased weight gain display 324, a total weight gain display 326, an improved feed efficiency display 328, and an additional revenue display 330.

The weight gain display 320 displays a baseline weight gain (0.76 kg/day), and also includes the feed efficiency display 322 that shows a baseline feed efficiency (34.5 g/kg), in this example.

The supplement effect display 324 displays the increased weight gain (0.1 kg/day) obtained through the use of the one or more selected feed supplements.

The total weight gain display 326 displays the total weight gain (0.86 kg/day), and also includes the improved feed efficiency display 328 that displays the improved feed efficiency (39.0 g/kg) achieved through the inclusion of one or more of the feed supplements, for example.

The additional revenue display 330 shows an increased revenue ($0.78) obtained through the use of the one or more feed supplements.

In some embodiments the displays 320, 324, 326, and 328 include circular meter displays, having the appearance of a speedometer, that allow the associated information to be quickly and easily understood by the user viewing the displays. In some embodiments the displays 322 and 328 are displayed within the displays 320 and 326, respectively.

As discussed herein, some embodiments include a routing mode of operation. As one example, the routing mode can be selectively turned on or off using a “routing” control not shown in FIG. 3. During the routing mode of operation, the meat production or weight gain can be fixed at a desired level, while the dry matter intake (kg), and/or the energy content are adjusted based on the inclusion of one or more supplements. The results are displayed in a routing section, for example. When one or more feed supplements are included, the routing section shows the reduced energy content of the feed that can be used while continuing to provide the meat producing animal with the appropriate metabolizable energy. Some embodiments also display the difference between the baseline required dry matter digestibility and the improved required dry matter digestibility achieved by use of the supplements.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method for estimating impact of a meat producing animal on carbon footprint, comprising:
providing one or more primary parameters associated with one or more of: a) a measure of energy content for a selected feed sample from a digestion model associated with the meat producing animal; b) a measure of dry matter digestibility for the selected feed sample from the digestion model associated with the meat producing animal; and c) an amount or a percent of components in the feed sample;
producing with a computing device a baseline performance comprising one or more of weight gain and feed efficiency using at least one or more of the primary parameters and one or more secondary parameters for the meat producing animal, wherein the one or more secondary parameters are associated with one or more of: a measure of animal weight, a measure of animal dry matter intake, a meat price, a breed of the animal, a measure of animal activity, and a measure of one or more environmental conditions; and
producing with the computing device a carbon footprint for the meat producing animal using the baseline performance.

2. The method of claim 1 wherein the one or more environmental conditions include temperature, humidity, time of year, wind speed, area of enclosure, and animal density per area of enclosure.

3. The method of claim 1 further comprising:
displaying the carbon footprint for the meat producing animal.

4. The method of claim 3 wherein the displaying comprises displaying the carbon footprint for the meat producing animal as a function of feed intake of the animal.

5. The method of claim 1 wherein the producing with the computing device comprises calculating with the computing device.

6. The method of claim 1 wherein the amount or a percent of components in the feed sample comprise a measure of fat, a measure of carbohydrate, a measure of protein, a measure of calories, a measure of fiber, a measure of calcium, or a measure of phosphorous.

7. The method of claim 1 wherein the digestion model is a chemical or biological fermentation model.

8. The method of claim 7 wherein the biological fermentation model is an in vitro biological model.

9. The method of claim 1 further comprising:
producing with the computing device feed efficiency in unit of feed consumed per unit of meat production.

10. The method of claim 1 further comprising:
producing with the computing device net energy required to support meat output in unit weight/time based at least in part on one or more of the primary parameters.

11. The method of claim 1 further comprising:
producing with a computing device escape protein in units of weight.

12. The method of claim 1 further comprising:
producing with the computing device a change in weight gain or feed efficiency for feed augmented with one or more feed supplements.

13. The method of claim 12 wherein producing with the computing device a change in weight gain or feed efficiency comprises an amount of the one or more feed supplements needed to obtain increased weight gain or feed efficiency.

14. A method for estimating impact of a plurality of meat producing animals on carbon footprint, comprising:
providing one or more primary parameters associated with one or more of: a) a measure of energy content for a selected feed sample from a digestion model associated with the meat producing animal; b) a measure of dry matter digestibility for the selected feed sample from the digestion model associated with the meat producing animal; and c) an amount or a percent of components in the feed sample;
producing with a computing device a performance for each animal comprising weight gain or feed efficiency using at least one or more of the primary parameters and one or more secondary parameters for each meat producing animal, wherein the one or more secondary parameters are associated with one or more of: a measure of animal weight, a measure of animal dry matter intake, a meat price, a breed of animal, a measure of animal activity, and a measure of one or more environmental conditions;
producing with the computing device a carbon footprint per animal using the baseline performance; and
aggregating the carbon footprint per animal for each animal of the plurality of meat producing animals to provide an aggregate carbon footprint.

15. (canceled)

16. (canceled)

17. (canceled)

18. The method of claim 14 wherein the plurality of meat producing animals includes animals of different species or from different phylogenetic families.

19. The method of claim 14 wherein the plurality of meat producing animals is animals of the same species or from same phylogenetic family.

20. (canceled)

21. (canceled)

22. (canceled)

23. (canceled)

24. (canceled)

25. The method of claim 14 further comprising:
producing with a computing device feed efficiency in unit weight of feed consumed per unit weight gain.

26. The method of claim 14 further comprising:
producing with a computing device NRC metabolizable protein required to support meat production in unit weight/time based on one or more of the primary parameters or based on one or more of the secondary parameters.

27. (canceled)

28. (canceled)

29. The method of claim 14 wherein producing with the computing device a change in weight gain or feed efficiency comprises calculating an amount of the one or more feed supplements needed to obtain an increase in weight gain or an increase in feed efficiency.

30. The method of claim 29 wherein the producing with a computing device a carbon footprint per animal includes producing a carbon footprint per animal using the increased weight gain or increased feed efficiency.

31. The method of claim 30 wherein the aggregating the carbon footprint per animal for each animal of a plurality of animals includes aggregating a carbon footprint per animal for each animal of the plurality of animals with feed augmented with the one or more feed supplements, to provide an aggregate carbon footprint as a function of an amount of the one or more feed supplements, weight gain, or feed efficiency.

32. The method of claim 31 further comprising:
displaying the aggregate carbon footprint as a function of the selected amount of the one or more feed supplements, weight gain or feed efficiency.

33. The method of claim 14 further comprising:
producing with a computing device a required protein level or protein savings.

34. A method for estimating an increase in one or more of weight gain and weight gain efficiency in a meat producing animal provided with animal feed containing one or more feed supplements, comprising:
providing a baseline performance comprising one or more of weight gain, meat production, and feed efficiency for the meat producing animal;
providing a selected amount of one or more feed supplements; and
producing with the computing device an increase in one or more of weight gain and feed efficiency in the meat producing animal fed using the selected amount of the one or more feed supplements relative to the baseline performance.

35. The method of claim 34 further comprising:
producing with a computing device a carbon footprint for the animal.

36. (canceled)

37. The method of claim 34 further comprising:
producing with a computing device a required dietary protein or protein savings.

38. A method for estimating an increase in one or more of weight gain and weight gain efficiency in a plurality of meat producing animals provided with animal feed containing one or more feed supplements, comprising:
providing a baseline performance comprising one or more of weight gain and feed efficiency for the plurality of meat producing animals;
providing a selected amount of one or more feed supplements; and
producing with a computing device an increase in one or more of weight gain and feed efficiency per animal in the plurality of meat producing animals fed using the selected amounts of the one or more feed supplements relative to the baseline performance.

39. The method of claim 38 further comprising:
producing with the computing device a carbon footprint per animal for each animal of the plurality of animals.

40. The method of claim 39 further comprising:
aggregating the carbon footprint per animal for each animal of the plurality of animals to provide an aggregate carbon footprint as a function of the selected amount of the one or more feed supplements, animal daily weight gain or feed efficiency.

41. (canceled)

42. A system for estimating the impact of a meat producing animal on carbon footprint, the system comprising:
at least one processing device; and
at least one computer readable storage device, the at least one computer readable storage device storing data instructions that, when executed by the at least one processing device cause the at least one processing device to generate:
a baseline performance engine configured to receive one or more primary parameters associated with one or more of a measure of energy content and a measure of dry matter digestibility, and to produce a baseline performance comprising one or more of weight gain and feed efficiency using at least one of the primary parameters and one or more secondary parameters, wherein the one or more secondary parameters are associated with one or more of a measure of animal weight, a measure of animal dry matter intake, a meat price, a breed of animal, a measure of animal activity, and a measure of one or more environmental conditions; and
a carbon footprint engine configured to use the baseline performance to produce a carbon footprint for the animal.

43. The system of claim 42 further comprising a display device, wherein the carbon footprint for the animal is displayed on the display device as a function of feed intake, weight gain, or feed efficiency of the animal.

44. The system of claim 42 further comprising a plurality of computing devices, wherein a first processing device is part of a first computing device.

45. The system of claim 42 wherein one computing device produces the baseline performance and the carbon footprint.

46. The system of claim 42 wherein the baseline performance engine operates on a first computing device and wherein the carbon footprint engine operates on a second computing device.

47. The system of claim 46 wherein the first computing device is in data communication with the second computing device across one or more data communication networks.

48. The system of claim 42 wherein the baseline performance engine is configured to calculate the baseline performance and the carbon footprint engine is configured to calculate the carbon footprint.

49. A system for estimating the impact of a plurality of meat producing animals on carbon footprint, the system comprising:
at least one processing device; and
at least one computer readable storage device, the at least one computer readable storage device storing data instructions that, when executed by the at least one processing device cause the at least one processing device to generate:
a baseline performance engine configured to receive one or more primary parameters associated with one or more of a measure of energy content and a measure of dry matter digestibility, the baseline performance engine further configured to produce a baseline performance comprising weight gain or feed efficiency using at least one of the primary parameters and one or more secondary parameters, wherein the one or more secondary parameters are associated with one or more of: a measure of animal weight, a measure of animal dry matter intake, a meat price, a breed of animal, a measure of animal activity, and a measure of one or more environmental conditions; and
a carbon footprint engine configured to use the baseline performance to produce a carbon footprint for each animal in the plurality of animals and aggregate the carbon footprint produced for each animal in the plurality of animals to provide an aggregate carbon footprint.

50. (canceled)

51. (canceled)

52. (canceled)

53. (canceled)

54. (canceled)

55. (canceled)

56. A method for adjusting a feed composition, comprising:
a) digesting a feed sample in an in vitro fermentation system for a meat producing animal to generate a value for a primary parameter comprising a) a measure of energy content for a selected feed sample from a digestion model associated with the meat producing animal; b) a measure of dry matter digestibility for the selected feed sample from the digestion model associated with the meat producing animal;
b) measuring one or more secondary parameters selected from the group consisting of animal weight, animal meat production, animal dry matter intake, animal meat price, animal activity, and an environmental condition to generate a value for the one or more secondary parameters;
c) producing a baseline performance value comprising meat production efficiency using at least one or more of the values of the primary parameters and one or more of the values of the secondary parameters using a computing device;
d) producing a carbon footprint for the meat producing animal using the baseline performance using a computing device; and
e) adjusting a component of the feed sample to change the baseline performance, the carbon foot print or both.

57. A method for adjusting a feed composition, comprising:
a) determining a characteristic of a first feed sample to generate a value for a primary parameter;
b) measuring one or more secondary parameters selected from the group consisting of animal weight, animal meat production, animal dry matter intake, animal meat price, animal activity, and an environmental condition to generate a value for the one or more secondary parameters;
c) producing a baseline performance value comprising meat production efficiency using the value of the primary parameter and one or more of the values of the secondary parameters using a computing device;
d) producing a carbon footprint for the meat producing animal using the baseline performance using a computing device; and
e) adjusting a component of the first feed sample to change either the baseline performance, the carbon foot print or both.

58. The method of claim 56, wherein the steps are repeated until a feed composition is identified that maintains or increases meat production efficiency and decreases carbon footprint as compared to the first feed sample.

59. The method of claim 56, wherein the in vitro digestion system comprises digesting the feed sample with one or more digestive enzymes in the presence of a microbial population.

60. The method of claim 57, wherein the characteristic of the feed sample is selected from the group consisting of a measure of protein, a measure of carbohydrate, a measure of fat, a measure of dry matter, a measure of gross energy and combinations thereof.

61. The method of claim 57, wherein the step of determining the characteristic of the feed sample comprises measuring a characteristic of the feed sample.

62. The method of claim 57, wherein the step of determining the characteristic of the feed sample comprises calculating a characteristic of the feed sample.

63. The method of claim 61, wherein the characteristic of the feed sample is determined by a chemical method or by near infrared spectroscopy.

64. The method of claim 56, wherein adjusting a component of the feed sample comprises adding a feed supplement to the feed sample.

65. The method of claim 64, wherein adjusting a component of the feed sample comprises altering the form of protein or amount of protein in the sample.

66. The method of claim 64, wherein adjusting a component of the feed sample comprises altering the digestibility of the feed sample.

67. The method of claim 56, wherein the step of producing a baseline performance comprises calculating a baseline performance.

68. The method of claim 56, wherein the step of producing a carbon footprint comprises calculating a carbon footprint.

69. The method of claim 56, wherein the step of producing a baseline performance comprises measuring a baseline performance.
